(19) United States
(12) Patent Application Publication
(10) Pub. No.: US 2004/0021927 A1
(43) Pub. Date: Feb. 5, 2004

(54) Electrochromic devices

(76) Inventors: Paul E Milne, Worcestershire (GB); John Simpson, Worcestershire (GB); Michael G Hutchins, Oxford (GB); Alexander J Topping, Oxfordshire (GB); Jose m Gallego, Lancs (GB)

Correspondence Address: NIXON & VANDERHYE, PC, 1100 N GLEBE ROAD, 8TH FLOOR, ARLINGTON, VA, 22201-4714, US

(21) Appl. No.: 10/312,714

(22) PCT Filed: Jun. 27, 2001
(86) PCT No.: PCT/GB01/02852

(30) Foreign Application Priority Data
Jun. 28, 2000 (GB) 0015664.6

(51) Int. Cl. G02F 1/15; G02F 1/153

(52) U.S. Cl. 359/265; 359/267

(57) ABSTRACT

An electrochromic arrangement particularly useful in a region of the infra-red spectrum above 3 microns comprises in order a rear glass substrate (1), a film electrode (2) with an IR reflectivity of at least 50%, an ion storage layer (3) an ion conducting layer (4). An electrochromic tungsten oxide layer (5) having at least a degree of crystallinity, a silicon front electrode (6) and an antireflection coating (7). In the uncharged state of layer (5) all layers (3-7) are transparent and most incident light is reflected at (2). On entering the charged state the layer (5) exhibits a marked increase in light absorptivity and refractive index. In a device incorporating a bare layer (5) the latter causes such a large increase in reflectivity at the front surface that the increase in light absorption tends to be masked, with a resulting increase in reflectivity of the device. Layer (6) acts as an index matching layer (6) whereby less light is reflected at the front of layer (5) and more light is transmitted through to be absorbed in charged layer (5) in both directions of transmission, so decreasing the reflectivity.

The present invention relates to electrochromic devices.

While the term “electrochromic” could be applied to any device in which the optical appearance alters in response to the application of an electric field, or to the insertion or removal of charge (for example a current due to passage of electrons or ions), and in particular such devices which undergo a wavelength selective change in visible absorption or reflection, in practice the term is normally used in a rather different sense as relating to devices exhibiting an optical absorption or reflection, not necessarily in the visible spectrum, which is changed in response to a change in its charge state, viz. the insertion or removal of charge. In some devices, the optical change may not be reversible on reversing the direction of charging, but for many applications a reversible change is desirable or necessary.

Such devices have been known for many years. In general they comprise an electrochromic material which responds to electrical charging, preferably reversibly. Examples of such materials include glassy materials which comprise an easily reducible species such as silver ions; solutions or gels that comprise a metallic ion such as silver which can be plated out onto a surface; solutions, gels and solid state phases including an organic material capable of undergoing a reversible redox reaction, such as viologens and phthalocyanines; and solid inorganic materials which can be reversibly altered, for example metal oxides. Of the latter class, tungsten oxide is probably the best known and most commonly employed in practical devices.

The employment of an electrochromic device can be particularly advantageous when high speed of response in not a prerequisite, and when it is desired to maintain the altered optical state over a long period without further energisation, for example in variable transmission windows. Such windows can be useful not only in controlling the amount of light entering an enclosure or incident on a component, for example a room in a building, but also for aiding the temperature control of an enclosure or component, for example a satellite or a component mounted thereon or therein.

The response of an electrochromic material to the passage of current can often, if not always, be regarded as an oxidation or reduction reaction, leading to the production of a new species exhibiting the changed optical property. However, where solid inorganic materials are involved, the process is often regarded as intercalation (insertion) of ions into the material or de-intercalation of ions from the material. Where ion insertion is necessary, it is common practice to interpose an ion conducting layer or electrolyte between an electrode and the electrochromic material to prevent direct passage of electrons or associated species. This layer may act as a storage layer for the ions to be inserted, or an additional layer may be provided for this purpose. The states of an electrochromic material as prepared (often the state which has zero or low absorption, and for tungsten oxide the state without intercalated ions), and as altered in response to a change in its charge (often the state which has increased optical absorption), will henceforth be referred to as the uncharged and charged states respectively. However, where the context permits the term “charging” should be regarded as covering insertion or removal of charge.

As discussed for example in “Visible and Infra-red Optical Constants of Electrochromic Materials for Emissivity Modulation Applications” by Jeffrey S Hale et al, Thin Solid Films 313-314 (1998) 205-209, and in “Prospects for IR Emissivity Control Using Electrochromic Structures”, Jeffrey S Hale et al, Thin Solid Films 339 (1999) 174-180, radiative heating of a satellite can be balanced through the emission of black body radiation therefrom. For an opaque body the emissivity e of a surface is complementary to the reflectance R:—

e=1−R.

While radiation balancing for satellites is commonly effected by louvres consisting of a series of highly reflective vanes which variably cover an emissive base plate under the control of bimetallic springs, the use of electrochromic devices would permit emittance modulation without bulky blinds and moving parts; furthermore, sensitive devices of small thermal mass could be directly covered by electrochromic coatings to provide even better thermal control.

For temperature control, it is highly desirable to be able to have optical control in the middle and far infra-red regions, and particularly in the 3 to 5 and/or 8 to 12 micron windows, where solar energy is relatively high but not absorbed by the eaith's atmosphere. However, many electrochromic devices exhibit high optical absorption in these regions whether or not charged, and so are not useful as variable absorption devices in the infra-red. This absorption can be due to the nature either of the electrochromic material itself, or of an associated component, such as an electrode or an electrolyte—for example if the electrolyte is, or comprises, an organic material. There are a few organic electrolytes, such as lithium triflate in propylene carbonate, which, although exhibiting significant optical absorption, can be formed into a layer which is sufficiently thin as to have a usefully low optical absorption in these regions and yet still provide sufficient conductivity.

U.S. Pat. No. 5,638,205 (Meisel) discloses a layer system with controllable heat emission for heat balancing of a spacecraft, the system comprising a variable “electroemissive” layer of polyaniline, nickel oxide, iridium oxide, molybdenum oxide or indium tin oxide sandwiched between a front substrate of silicon, germanium, zinc sulphide or selenide, barium or calcium fluoride, polyethylene, polypropylene or PTFE and an infra-red reflecting electrode layer. An infra-red absorbing electrolyte and an ion storage layer are sandwiched between the infra-red reflecting electrode and a rear electrode, a voltage being applied between the two electrodes in use, and it is necessary for the infra-red reflecting electrode to be porous to allow passage of ions into the variable electroemissive layer. In addition, the embodiment comprises a grid electrode between the electroemissive layer and the front substrate which is held at the same potential as the porous electrode for promoting the movement of ions into the electroemissive layer. As claimed therein, the porous electrode is provided with non-cohesive distributed homogeneously openings with a maximal flat dimension of less than 10 microns to maintain a high IR reflectivity. Reference is made to two related prior art specifications, DE 3643691 and DE 3643692, in which the action in inorganic electroemissive layers such as lead fluoride appears to be the reduction to the metallic species.

By contrast, porous electrodes are not a necessary feature of the present invention, and the embodiments of the present invention herein described comprise two continuous electrodes either side of an electrochromic layer, a potential difference being applied in use between these electrodes, i.e. across the electrochromic layer.

In the case of electrochromic devices comprising tungsten oxide, the amorphous state has been most extensively used and investigated, and is considered commercially useful for its variable light absorption in the visible and near infra-red regions, generally in the range 650 nm to 2.5 microns. However, beyond 2.5 microns this material does not exhibit electrochromic switching, and also exhibits relatively high absorption. Typical electrochromic arrangements using tungsten oxide of an unspecified form are disclosed in U.S. Pat. No. 3,578,843 (American Cyanamid) (a reflective device); and U.S. Pat. No. 6,055,088 (Fix), International Patent No. WO93/05438 (Sun Active Glass) and International Patent No. WO94/15427 (Sun Active Glass) (all variable transmission devices).

More recently, attention has been directed to tungsten oxide in the semi-crystalline (or poly-crystalline) state. See, for example, Hutchins M G, Butt N S, Topping A J, Gallego J, Milne P, Jeffrey D and Brotherston I, Infra-red Reflectance Modulation In Tungsten Oxide Based Electrochromic Devices, International Meeting on Electrochromics IME 4, Uppsala, Sweden, August 2000, Electrochimica Acta 46/13-14, 1983-1988, 2001. See also U.S. Pat. No. 6,094,292 (Goldner) discussed below.

The existence and degree of crystallinity can be determined for example by X-ray diffraction techniques. As used herein, the term “crystalline” will be used to describe materials exhibiting at least a degree of crystallinity as determined by any well known technique, and is not limited to wholly crystalline materials. As long as crystalline properties can be detected, this is sufficient for a material to be described as “crystalline”.

Crystalline films of inorganic materials, including metallic oxides, may be obtained by a variety of methods known per se, including rf/dc magnetron sputtering. One way of controlling the degree of crystallinity of an rf/dc magnetron sputtered film is by varying the temperature of the substrate, see for example, the article by Hale mentioned above.

As the crystallinity of a tungsten oxide film increases, the transmissivity of the (uncharged) film at wavelengths greater than 2 microns also increases markedly, thereby potentially opening the way to its use as a variable optical absorber in the middle and far infra-red regions, since the charged state is still highly absorbing, i.e. there is now a substantial increase in light absorption of light entering, the material when it becomes charged.

However, whereas the real part N of the refractive index of the uncharged (low absorption) film is about 2, that of the charged form is about 4. That is to say, the transition to the charged state is marked by significant increases in both parts of the complex refractive index. The high real refractive index, particularly in the charged state, means that in use a relatively large amount of light can be reflected from the surface of the film without entering it, and so cannot be absorbed. The fraction of light reflected from an interface between substrates having real refractive indices NA and NB is given by (NA−NB)²/(NA+NB)². For a polycrystalline tungsten oxide layer in air, the front surface reflects less than 10% of incident infra-red radiation when uncharged, and about 60% when charged.

Attempts have therefore been made to use the variation in the real part N of the refractive index of crystalline tungsten oxide films as a major light controlling property in reflectance modulating devices, where a principal reflection occurs at the face of the tungsten oxide film on which the light is first incident. In many reflectance modulation electrochromic devices, the large variation in optical absorption (corresponding to the change in the complex part k of the complex refractive index) plays a relatively insignificant role.

In devices based on polycrystalline tungsten oxide, the increased refractive index in the charged state might be expected to give an increase in the amount of light reflected from the device in that state, but this is not always the case. The degree of modulation exhibited by a variable reflectivity device incorporating a polycrystalline tungsten oxide layer, and whether the amount of light reflected is greater or less when the device is charged, depends also on the device construction and the other materials of the device. In any case it is commonly found that in practice the resulting degree of modulation is actually rather low.

Consider, for example, a typical device comprising, in order, a (rear) reflective substrate, an ion storage layer, ion conducting layer (electrolyte), a polycrystalline tungsten oxide electrochromic layer, and a (front) grid electrode. For simplicity it will be assumed that no reflection occurs at interfaces within the device, and that the uncharged tungsten oxide layer is effectively transparent. The modulation index is a function of the intensity of reflected light intensity only.

If the ion storage and ion conducting layers are effectively transparent, then in the uncharged state all of the incident light should be reflected back because none of it is transmitted or absorbed. When the tungsten oxide layer is charged, a significant portion of the light is reflected at its front surface, some or all of the remainder being absorbed in the layers, so that the amount of reflected light falls. The large reflection occurring at the front surface in the charged state thus sets a lower limit to the reflectivity and severely limits the modulation index.

However, if the ion storage layer and/or the ion conducting layer are effectively 100% light absorbing, then reflection by the rear electrode has no part to play. The only light reflected by the uncharged device is that from the front surface, of relatively low intensity as the refractive index of the uncharged tungsten oxide is also relatively low. However, it would be expected that the increase in refractive index when the electrochromic layer is charged would give rise to a corresponding and significant increase in the amount of the incident radiation that is reflected. Therefore in this case, there is more light reflected in the charged state, despite the increase in absorptivity of the tungsten oxide layer. The modulation index is determined principally by the different amounts of reflection at the front surface of the tungsten oxide layer as it is switched between charged and uncharged states.

An example of the above typical device, with effectively transparent ion storage and ion conducting layers, is described in the previously mentioned articles by Hale. This device comprises a conductive top grid electrode on a polycrystalline tungsten oxide electrochromic film, a tantalum oxide ion conductor film, a nickel oxide/hydroxide ion storage film and finally a reflective gold electrode. Modelling of the device provides calculated results for reflectance modulation where the ions are hydrogen ions, although lithium ions are also mentioned. It is recognised that there is a larger change in the optical constants of tungsten oxide with intercalation of hydrogen ions as opposed to lithium ions, and it is also recognised that there is a large difference in the optical constants between the intercalated amorphous and crystalline films, with crystalline materials being the best choice for reflectance modulation, especially in the infra-red.

It is also recognised that while in the device is in the uncharged state the gold electrode is responsible for a large degree of reflection, with the overlying layers being largely transparent in the infra-red regions of interest, the charged device has a reflectivity as determined by the surface of the tungsten oxide layer. By suitably adjusting the thickness of the nickel oxide and tungsten oxide films (the later article refers to adjustment of the thickness of the tungsten oxide film to obtain an interference effect in the infra-red positioned near the peak of the 300° K blackbody spectrum), the emissivity could be altered from 0.057 to 0.595 over the 2 to 13.8 micron region, a ratio of 10.4:1, compared with a typical ratio of 7 for venetian blind apparatus.

It is to be noted that in the arrangements of these two prior art articles by Hale, the tungsten oxide layer is directly open to incident radiation where the conductive grid does not intervene. Because the layers overlying the gold electrode are all substantially transparent in the infra-red when the tungsten oxide is in the uncharged state, the reflectance is at a maximum, and approaches unity in some wavelength bands. When the tungsten oxide layer is in the charged state, its refractive index and absorption coefficient both increase significantly. While increased reflection occurs at the front (exposed) surface of the tungsten oxide layer, much or most of the transmitted light is absorbed in the tungsten oxide layer, so that the overall amount of reflected light is reduced.

This type of arrangement was also disclosed in a poster (“Polycrystalline WO3 Based Electrochromic Devices for IR Reflectivity Modulation” C L Trimble et al) and in a presentation “Infra-red Emittance Modulation Devices Using Electrochromic Crystalline Tungsten Oxide, Polymer Conductor, and Nickel Oxide”, C L Trimble et al) at a conference at the Center for Microelectronic and Optical Materials Research, Department of Electrical Engineering, University of Nebraska-Lincoln. Also disclosed on this occasion were devices comprising, in order, a tin oxide/glass transparent electrode, a (hydrated) nickel oxide layer, an electrolyte layer with organic components, a polycrystalline tungsten oxide layer, and a silicon electrode for first receiving incident infra-red radiation.

This latter device includes a silicon electrode over the forward facing surface of the tungsten oxide layer. While this electrode layer may provide index matching to the tungsten oxide layer and so provide an increase in light transmitted into the tungsten oxide layer, as required in the present invention to be described below, this prior art arrangement is not arranged to utilise this effect. Although the organic electrolyte could, as mentioned above, be selected to have a relatively low extinction coefficient, this layer is so much thicker than any of the other layers that it is to be expected that the organic electrolyte will absorb a large amount of any radiation transmitted thereto, e.g. when the tungsten oxide layer is in the uncharged state, and that little radiation will be reflected from the device in that state. Furthermore, compared with many metallic or specifically provided dielectric reflectors, the tin oxide/glass electrode has a markedly inferior reflectivity in the infra-red, for example less than 30% in the 3 to 5 and 8 to 12 micron regions, so that even if some light were to pass through the electrolyte most of it would not reflected back again. By contrast the present invention requires a good infra-red reflector, and that all of the other layers of the stack are generally light transmissive (with the electrochromic layer uncharged), so that reflection can be maximised.

In this prior art device it is worth noting that when the tungsten oxide layer is in the charged state there will be a somewhat increased amount of infra-red radiation reflected from its front surface due to the large refractive index in that state, and an increased mismatch of index with the overlying silicon layer. However, the index mismatch is reduced by the overlying silicon layer, and is expected to provide around 6% reflected light when the device is charged, assuming a refractive index of 2.4 for the silicon layer. This seems consistent with the fact that the reflectivity modulation of this sort of device appears to be relatively low.

U.S. Pat. No. 6,094,292 (Goldner) also discloses a similar device with a continuous electrode layer (e.g. indium oxide or indium tin oxide), using polycrystalline tungsten oxide as the electrochromic material, which is particularly described in respect of variable transmission in the 0.65 to 2.5 micron range. In each of the embodiments, the reflectance of the device is significantly higher when the electrochromic layer is charged, indicating that reflection at the front surface (nearer the incident radiation) of the charged layer dominates optical absorption by that layer. The refractive index mismatch between charged tungsten oxide and the electrode layer is believed to be significant. Furthermore, the electrode materials become infra-red blocking at wavelengths much over 2.5 microns.

It will be seen that in each of these prior art devices, the significant variable leading to modulation is the variation of the real refractive index of the tungsten oxide layer. The accompanying large variation in absorption coefficient may play some part, but it is not the main factor. The significant increase in reflection at the surface of a charged layer could be regarded as the dominant feature, preventing much of the light from entering the layer for optical absorption.

It is an object of the present invention to provide a reflective electrochromic device for the modulation of infra-red radiation, in which a principal property of the electrochromic material affecting the modulation is variation of absorptivity. It is also an object of the invention to facilitate the provision of such a device which is useful at wavelengths over 3 microns. As in known prior art devices, electrochromic arrangements according to the invention can be made which are stable in either switched state (and normally in intermediate states as well) thus only requiring power when switching is necessary.

In a first aspect, the present invention provides an electrochromic arrangement for use in a region of the infra-red spectrum, said arrangement comprising a stack of layers including an electrochromic layer having first and second opposed surfaces, and means to alter the charge in the electrochromic layer to change it between a first state which in said region is relatively transparent and exhibits a first refractive index, and a second state which in said region is relatively absorbing and exhibits a second refractive index, wherein

a reflector having a reflectivity of at least 50% in said region is opposed to the second surface of the electrochromic layer;

the stack of layers includes an index matching layer in effective optical contact with said first surface for reducing the amount of light in said region reflected at the said first surface relative to an interface of said first surface with air; and

the optical path between the said index matching layer and the reflector is generally light transmissive in said region when the electrochromic layer is in its first state. In preferred embodiments, the reduction in the amount of reflected light is effective when said electrochromic layer is in the charged state.

In a second aspect, the present invention provides an electrochromic arrangement for use in a region of the infra-red spectrum, said arrangement comprising a stack of layers including an electrochromic layer having first and second opposed surfaces, and means to alter the charge in the electrochromic layer to change it between a first state which in said region is relatively transparent and exhibits a first refractive index, and a second state which in said region is relatively absorbing and exhibits a second refractive index greater than the first, wherein

a reflector having a reflectivity of at least 50% in said region is opposed to said second surface, the optical path between the said first surface and the reflector being generally light transmissive in said region when the electrochromic layer is in its first state; and the stack of layers includes a layer in effective optical contact with said first surface for index matching therewith when the electrochromic layer is in the second state such that switching the electrochromic layer to its second state decreases the reflectivity of the arrangement.

In the first and second aspects, preferably the amount of light reflected at the said other surface in said region is less than 25% when the electrochromic layer is in its charged state.

In a third aspect the invention provides an electrochromic arrangement for use in a region of the infra-red spectrum, said arrangement comprising a stack of layers including an electrochromic layer, and means to alter the electrical charge in the electrochromic layer to change it between a first state which is relatively transparent in said region and which has a first real refractive index N1, and a second state which is relatively absorbing in said region and which has a second real refractive index N2, wherein

a reflector having a reflectivity of at least 50% in said region is opposed to one surface of the electrochromic layer;

the stack of layers includes an index matching layer in effective optical contact with the other surface of the electrochromic layer, the real refractive index N3 of the index matching layer being such that the value of (N2−N3) is less than or equal to 2; and

the optical path between the said index matching layer and the reflector is generally light transmissive in said region when the electrochromic layer is in its first state. Preferably the modulus of (N2−N3) is less than or equal to 2.

The index matching layer is provided to increase the amount of light entering the electrochromic layer in its second state via the other surface, so that more light can be absorbed, and so that less light is reflected directly from the other surface of the electrochromic layer. Where the index matching layer is the first layer encountered by the incident radiation, there could be a problem with reflection at its front surface. Therefore, preferably, the end of the stack on the side of the electrochromic layer remote from the reflector is provided by an antireflection layer or stack, or the surface of the index matching layer remote from the electrochromic layer is provided with an antireflection layer or stack. However, under certain circumstances, it may be possible to arrange that the index matching layer itself acts as an antireflection interference layer.

In a fourth aspect, the present invention provides an electrochromic arrangement for use in a region of the infra-red spectrum, said arrangement comprising a stack of layers including an electrochromic layer, and means to alter the electrical charge in the electrochromic layer to change it between a first state which is relatively transparent in said region and which has a first refractive index, and a second state which is relatively absorbing in said region and which has a second refractive index, wherein

a reflector having a reflectivity of at least 50% in said region is opposed to one surface of the electrochromic layer;

the stack of layers includes an index matching layer in effective optical contact with the other surface of the electrochromic layer for reducing the amount of light in said region reflected at the said other surface relative to an interface of said other surface with air; and

the stack is arranged to form an interference structure in which light in said region is effectively reflected from the arrangement when the electrochromic layer is in its first state and is absorbed by said electrochromic layer when in its second state.

The means for altering the electrical charge in the electrochromic layer, that is either inserting or removing charge, or passing current therethrough in either direction, commonly comprises first and second electrodes either side of the electrochromic layer. At least one of an ion transmitting layer and an ion storage layer may be disposed between one of the electrodes and the electrochromic layer. In embodiments of the invention, an ion transmitting layer is disposed between the electrochromic layer and an ion storage layer. The ion transmitting layer movement of suitable ions between the ion storage layer and the electrochromic layer under the influence of a potential difference between the electrodes during use while effectively preventing movement of ions in the absence of a potential difference, thereby giving stability to the charged and discharged states of the device.

The ion storage layer could be for example of a material selected from cerium oxide, vanadium oxide, titanium oxide, nickel oxide, tin oxide, amorphous tungsten oxide and mixtures thereof. The ion conductive (or electrolyte) layer could be for example of a material selected from tantalum oxide or lithium niobate and niobium pentoxide.

Preferably, the ion storage and/or ion conductive layer is/are located on the same side of the electrochromic layer as the reflector. However, it is also possible to interpose the ion storage and/or ion conductive layer on the other side of the electrochromic layer, and in such a case one such layer could, but does not necessarily, constitute the index matching layer. Also in that case, the reflective layer could be located immediately adjacent the electrochromic layer.

The electrodes and other layers of the stack can act only as such, or serve more than one function. For example, the (front, i.e. on the side of the electrochromic layer remote from the reflector) electrode may also serve as the index matching layer. Alternatively, or additionally, the (rear) electrode may serve as the reflector.

The front electrode could be of grid form, for example if it is of infra-red reflecting or absorbing material such as tin oxide or gold, and overlaid by an insulating or conducting index matching layer. However, it is preferably a continuous layer, for example of silicon or germanium. In such a case, this layer could also function as the index matching layer. In one embodiment an index matching layer of silicon or other semiconductor is modified by doping the region immediately in contact with the electrochromic layer to serve as a conductive electrode region. This region is made sufficiently thin as not to interfere with the index matching function.

Arrangements according to the invention comprise a good reflector or reflective surface, providing at least 50% reflection of normally incident light in the operative infra-red region, preferably at least 75% reflection, more preferably at least 90% reflection. By arranging for all the other layers of the stack prior to the reflector to be effectively light transmissive when the electrochromic layer is in its first state, the arrangement may be more reflective overall (for example, preferably at least 50%, more preferably at least 75%, even more preferably at least 90%, and ideally substantially 100%). This in turn sets lower limits of light transmission by all the layers prior to the reflector taken together, and also by any single layer prior to the reflector of 50%, 75%, 90% and 100%. In preferred embodiments the light transmission by the most absorbing layer is at least 80%, more preferably 90%, even more preferably 95% and most preferably all layers are substantially 100% transmissive. In part this is accomplished by the choice of material, but it is also aided by the thinness of the layers (see below).

The reflective surface may be provided by a reflective layer on the stack, by a reflective layer on a substrate, or by a solid substrate, and may be formed for example of gold or aluminium. As mentioned above, where the reflector is electrically conductive or metallic, it can also act as an electrode forming part of the means for passing current or ions into (altering the charge in) the electrochromic layer.

However, a separate electrode may be provided for this purpose, in which case the reflector could still be metallic and/or conductive, but could alternatively be non-conductive, typical examples being a passivated metal (e.g. anodised aluminium) or a dielectric reflector of known type. Infra-red transmissive electrically conductive material, for example a semiconductor or tin oxide, could be deposited over a non-conductive reflector.

Alternatively a porous dielectric reflector could be accommodated within the stack, rather than at one end thereof, for example within an ion conductive layer or an ion storage layer. This may have the effect of bringing the reflector closer to the electrochromic layer, so that optical requirements for layers behind the reflector (for example an ion storage layer and/or an ion conducting layer) are reduced or no longer exist.

The material of the index matching layer may be selected from silicon, germanium, zinc sulphide, calcium fluoride and tin oxide. Preferably the reflectivity at the said other surface of the electrochromic layer is less than 10%, more preferably less than 5%, and even more preferably substantially zero. In a preferred embodiment where the electrochromic layer comprises polycrystalline tungsten oxide and the index matching layer is silicon, the calculated interface reflectivity is around 4%.

Index matching in accordance with the second aspect of the invention is defined as a difference in the modulus of the real refractive index difference (N2−N3) of less than 2, and more preferably less than 1. When the electrochromic material is polycrystalline tungsten oxide, N2 is approximately 4. Setting N3 to 2 gives a calculated interface reflectivity of 16.7%, and this value does not rise above 25% until N3 is greater than around 55. Even if N2 is as great as 6, an index N3 of 4 still gives a calculated reflectivity of only 25%.

All the layers of the stack, with the possible exception of an antireflection layer and the reflector, may be, and preferably are, thin layers. Preferably no layer of the stack, or no interior layer of the stack, has a thickness greater than 1 micron, and in the embodiment no such layer is more than 0.4 microns thick. The stack therefore often requires to be supported, either on its first or second surface, either by a substrate or by using a sufficiently thick external layer.

For example, the rear reflector may be deposited on a substrate, in which case it would possible to lay down the stack from the bottom in sequence by methods known per se, commencing with the substrate. The substrate could be of glass or metal, or of a flexible material such as a polymer (see below) for example. The reflector could be a metallic film or interference mirror.

Alternatively, if the top layer is a suitably thick silicon or other wafer acting as an index matching layer, or if a top antireflection stack is sufficiently thick, it would be possible to deposit the stack from top to bottom on the wafer.

Of course, it would also be possible to deposit the stack in two complementary halves, on respective relatively thick supports, for subsequent joining. Furthermore, certain applications such as local protection of a sensitive component by depositing conforming layers therearound will determine the manner in which the stack is to be grown. In addition, white it needs to provide sufficient support, the substrate can be flexible or rigid. A flexible substrate may be useful when the device is applied to an object which is expected to undergo a degree of deformation during its lifetime. Alternatively, it may be that such an object actually serves as the substrate on which the rest of the device is formed.

The prior art devices employing a crystalline tungsten oxide layer generally have a surface of the tungsten oxide layer either forming an interface with air, or at most covered with an electrode, so that the variation in reflectivity of the tungsten oxide film may be used. The present invention relies more on the variation in absorption by the electrochromic layer and it is not necessary for the electrochromic layer to be immediately exposed to the incident light, i.e. adjacent or towards the front of the device. In one embodiment to be described later, an electrochromic layer is located below a plurality of layers, and may, indeed, be adjacent a rear reflector. In such a construction, another layer, including a layer necessary to the operation of the device, such as an ion conducting layer or ion storage layer, fulfils the function of index matching to the electrochromic layer.

Thus in a fifth aspect the invention provides an electrochromic arrangement for use in a region of the infra-red spectrum, said arrangement comprising a stack of layers including an electrochromic layer, and means to alter the electrical charge in the electrochromic layer to change it between a first state which is relatively transparent in said region and which has a first refractive index, and a second state which is relatively absorbing in said region and which has a second refractive index, wherein

a reflector having a reflectivity of at least 50% in said region is opposed to one surface of the electrochromic layer;

the stack of layers includes an ion conduction or ion storage layer in effective optical contact with the other surface of the electrochromic layer; and

the optical path to the reflector is generally light transmissive in said region when the electrochromic layer is in its first state.

Considerations applicable to the first four aspects of the invention also apply to the fifth aspect. In an embodiment, the electrochromic layer is immediately adjacent a rear reflective electrode.

In the preferred embodiments of the invention, the electrochromic layer comprises crystalline tungsten oxide as herein defined. This shows absorption bands which embrace the 3 to 5 and 8 to 12 micron spectral windows. It has been found that control of the conditions under which the polycrystalline tungsten oxide film is deposited enables control not only of the degree of crystallinity thereof, but also of the precise absorption spectrum and refractive index, thereby facilitating adjustment of the optical characteristics of a device according to the invention. However, it is envisaged that the invention could be useful with any electrochromic layer undergoing an increase of refractive index of at least 40%, more preferably at least 75%, and most preferably at least 90%, when switching to the higher refractive index state.

Using a device according to the invention, it is possible to achieve light modulation at wavelengths greater than 2 microns, more preferably greater than 3 microns, and a preferred application is for modulation of infra-red light in the 2 (or 3) to 15 micron region.

By adjusting the thickness of the layers of the stack, and optionally their composition, it is possible to adjust the regions where light absorption preferentially occurs, so as to shift these regions somewhat. The fourth aspect of the invention relates to interference structures and embraces the use of interference as a means of concentrating light in the electrochromic layer in known manner. However, in any aspect of the invention, the use of interference and/or multiple reflections at interfaces of the stack, for example by adjusting the thicknesses of the layers of the stack, may be used to adjust the wavelength regions in which the device is effective. In particular, the stack may be arranged for preferential absorption of light in the 8 to 12 micron window, relative to the absorption of light in the 3 to 5 micron window, when the electrochromic layer is in its second state.

In the uncharged state, the complex part k of the refractive index is close to zero. As ion insertion into polycrystalline tungsten oxide progresses, so does the absorptivity and the value of k. However, this is not a linear process but appears to involve at least two sequential steps. In the first step, the absorption in the 3 to 5 micron window develops preferentially over the 8 to 12 micron window, and absorption in the latter band develops more in the second step. It is therefore possible to operate a device comprising polycrystalline tungsten oxide so that the amount of ions inserted into the tungsten oxide layer in the second state is controlled for preferential absorption in the 3 to 5 micron window, relative to light in the 8 to 12 micron window. By contrast, the change in the real part N of the refractive index with charge is a generally linear process.

In the invention the amount of light incident on the device and immediately reflected at the first surface of the electrochromic layer in its second state is reduced, preferably substantially, by appropriate index matching between the electrochromic layer in its second state and the index matching layer. A greater amount of light is transmitted into the electrochromic layer, where a substantial fraction thereof is absorbed and cannot be reflected back out of the device. Compared with the known prior art devices mentioned above which also include a reflective substrate but a “bare” tungsten oxide layer, the amount of light reflected in the second state can be much reduced.

When the electrochromic layer is in its first state, index matching tends to be less relevant, because all other layer are generally transmissive—whatever the degree of index match or mismatch, most light which is transmitted through the electrochromic layer is reflected at the substrate and reflected back out of the device, to add to the light reflected at the said first surface, and so most of the light is reflected when the electrochromic layer is in its first, least absorbing, state. This is the opposite result from that obtained with other known prior art devices, for example the device described above which includes a polymeric electrolyte, where greater reflectivity can occur when the electrochromic layer is in its more absorbing state.

It will be noted that the index matching layer is not suggested for transmissive arrangements since it is believed this would be counterproductive. Assuming that the electrochromic layer is an imperfect absorber, a certain fraction of the light entering it will leave from the other side. In the “transmissive” state the fraction of incident light which is reflected is expected to be very similar whether or not the matching layer is present. However, the index matching layer serves to increase the amount of light entering the electrochromic layer in the “light blocking” charged state, so increasing the amount of transmitted light and reducing the modulation index relative to a “bare” or non-index matched electrochromic layer.

Further features and advantages of the invention may be obtained by a consideration of the appended claims, to which the reader is referred, and also by a reading of the following description of preferred exemplary embodiments of the invention, made with reference to the accompanying drawings, in which

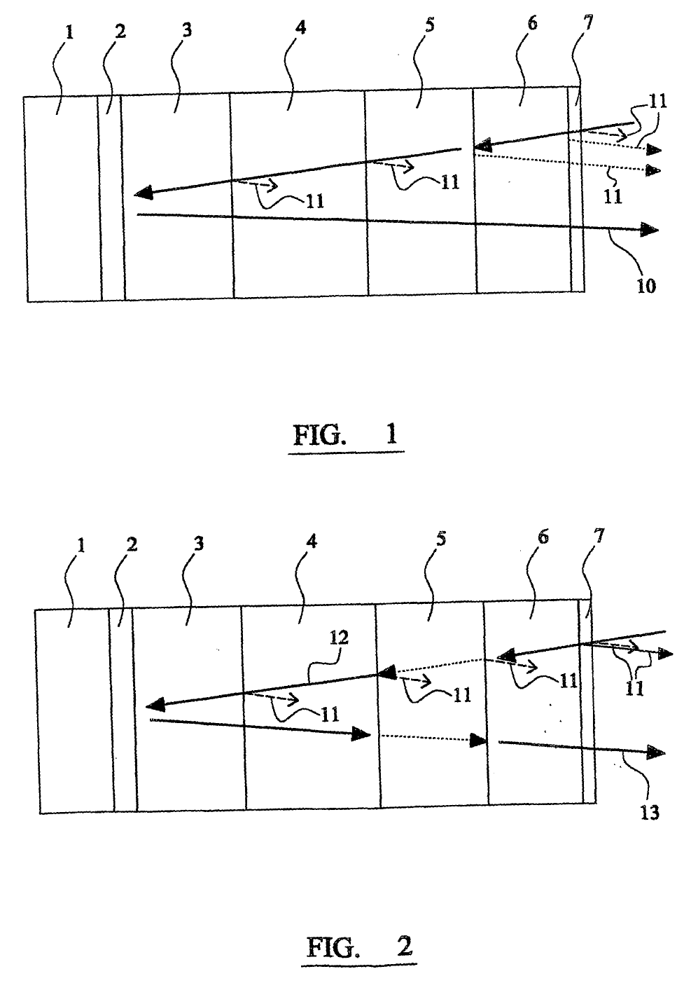

FIGS. 1 and 2 show an arrangement according to the invention in the form of a device, in side cross-sectional view, for different states of the electrochromic layer;

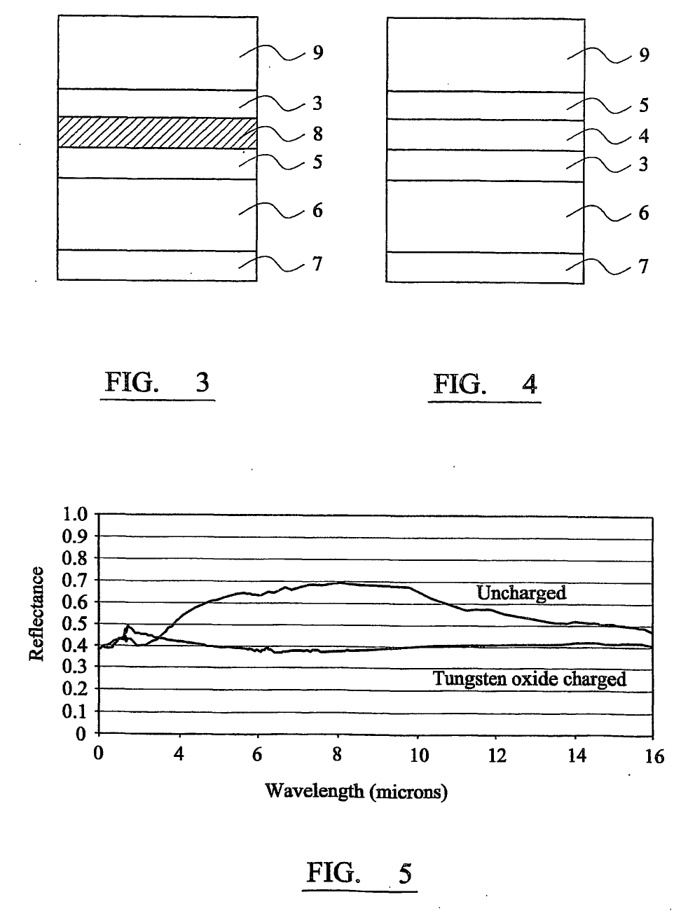

FIGS. 3 and 4 respectively show other devices according to the invention in side cross-sectional view; and

FIG. 5 is a plot of measured reflectance against wavelength for an experimental arrangement according to the invention.

The same reference numbers are used for equivalent features in all of the Figures.

In FIG. 1, an infra-red reflective counter-electrode film 2, for example of aluminium or gold, is deposited on a rigid glass substrate 1, over which is deposited an infra-red transparent ion storage layer 3, for example a 200 nm thickness of nickel oxide, and an infra-red transparent ion conducting layer 4 such as a 100 nm layer of tantalum oxide, followed in turn by a 200 nm thick uncharged polycrystalline tungsten oxide layer 5, a silicon electrode layer 6, and anti-reflection layer 7. Here the silicon electrode layer 6 provides index matching to the electrochromic layer 5.

Although some minor reflections 11 (as indicated by the thin arrows) occur at interfaces between layers, the main reflection 10 is provided by the film 2. It will be appreciated that wherever the reflections occur, there is little or no light absorption, and no transmission, so that substantially all of the light is eventually reflected back out of the device.

FIG. 2 shows the same device, where hydrogen ion transfer to the tungsten oxide layer 5 has occurred. Although there remains a small amount of light reflection 11 at the front surfaces of layers 7, 6 and 5 most of the light enters the absorbing layer 5 and does not reappear on either side thereof. Even if some light 12 is transmitted to the electrode 2, much of it will be absorbed in layer 5 on the return journey, so that the intensity of the reflected beam 13 has a very low value.

In a first modification of the device shown in FIGS. 1 and 2, the ion storage layer 3 is of amorphous tungsten oxide but is sufficiently thin to exhibit low infra-red absorption. In a second modification, the ion storage layer 3 is of vanadium titanium oxide and lithium ions are transferred between/across the layers 3 to 5.

FIG. 3 shows a device in which the rear electrode is constituted by a solid metal substrate 9, e.g. of aluminium. An layer 8 comprising an ion conductive medium is located between the ion storage layer 3 and the electrochromic layer 5 and further includes a reflector in the form of a porous dielectric reflector of known construction. While the surfaces of the dielectric reflector could be spaced from the boundaries of layer 8 by the ion conductive medium, as shown the latter is a liquid or gel and is accommodated within the pores of the reflector, which thus defines the physical boundaries of the layer 8 in contact with the adjacent layers. It will be understood that a similar construction is possible where the ion storage layer 5 alternatively or additionally includes a dielectric reflector in a similar manner.

FIG. 4 shows a device in which the order of the layers 3 to 5 is reversed compared with the previous embodiments. The electrochromic layer 5 is deposited on substrate 9, followed by the ion conducting layer 4, the ion storage layer 3, a top electrode layer 6 and an antireflection layer or stack 7. Here the ion conducting layer 4 provides index matching to the electrochromic layer 5.

FIG. 5 indicates the experimental result for one solid state reflective device according to the invention, and it will be seen that the reflectance is greater in the uncharged state, with the device exhibiting a maximum reflectance of ˜0.7 and a minimum reflectance of ˜0.4 in the uncharged and charged states.

1. An electrochromic arrangement for use in a region of the infra-red spectrum, said arrangement comprising a stack of layers including an electrochromic layer having first and second opposed surfaces, and means to alter the charge in the electrochromic layer to change it between a first state which in said region is relatively transparent and exhibits a first refractive index, and a second state which in said region is relatively absorbing and exhibits a second refractive index, wherein
a reflector having a reflectivity of at least 50% in said region is opposed to the second surface of the electrochromic layer;
the stack of layers includes an index matching layer in effective optical contact with said first surface for reducing the amount of light in said region reflected at the said first surface relative to an interface of said first surface with air; and
the optical path between the said index matching layer and the reflector is generally light transmissive in said region when the electrochromic layer is in its first state.

2. An arrangement according to claim 1 wherein said reduction in the amount of reflected light is effective when said electrochromic layer is in the charged state.

3. An electrochromic arrangement for use in a region of the infra-red spectrum, said arrangement comprising a stack of layers including an electrochromic layer having first and second opposed surfaces, and means to alter the charge in the electrochromic layer to change it between a first state which in said region is relatively transparent and exhibits a first refractive index, and a second state which in said region is relatively absorbing and exhibits a second refractive index greater than the first, wherein
a reflector having a reflectivity of at least 50% in said region is opposed to said second surface, the optical path between the said first surface and the reflector being generally light transmissive in said region when the electrochromic layer is in its first state; and the stack of layers includes a layer in effective optical contact with said first surface for index matching therewith when the electrochromic layer is in the second state such that switching the electrochromic layer to its second state decreases the reflectivity of the arrangement.

4. An electrochromic arrangement according to any preceding claim, wherein the amount of light reflected at said first surface in said region is less than 25% when the electrochromic layer is in its charged state.

5. An electrochromic arrangement for use in a region of the infra-red spectrum, said arrangement comprising a stack of layers including an electrochromic layer having first and second opposed surfaces, and means to alter the charge in the electrochromic layer to change it between a first state which in said region is relatively transparent and exhibits a first refractive index N1, and a second state which in said region is relatively absorbing and exhibits a second refractive index N2, wherein
a reflector having a reflectivity of at least 50% in said region is opposed to said second surface;
the stack of layers includes an index matching layer in effective optical contact with said first surface, the refractive index N3 of the index matching layer being such that (N2−N3) is less than or equal to +2; and
the optical path between the said index matching layer and the reflector is generally light transmissive in said region when the electrochromic layer is in its first state.

6. An arrangement according to claim 5 wherein the modulus of (N2−N3) is less than or equal to 2.

7. An arrangement according to any preceding claim wherein the end of the stack remote from the reflector is provided by an antireflection layer or antireflection stack.

8. An arrangement according to claim 7 wherein the index matching layer acts as said antireflection layer.

9. An arrangement according to any one of claims 1 to 7 wherein the surface of the index matching layer remote from the electrochromic layer is provided with an antireflection layer or antireflection stack.

10. An electrochromic arrangement for use in a region of the infra-red spectrum, said arrangement comprising a stack of layers including an electrochromic layer having first and second opposed surfaces, and means to alter the charge in the electrochromic layer to change it between a first state which is relatively transparent in said region and which has a first refractive index, and a second state which is relatively absorbing in said region and which has a second refractive index, wherein
a reflector having a reflectivity of at least 50% in said region is opposed to the second said surface;
the stack of layers includes an index matching layer in effective optical contact with said first surface for reducing the amount of light in said region reflected at the said first surface relative to an interface of said first surface with air; and
the stack is arranged to form an interference structure in which light in said region is effectively reflected from the arrangement when the electrochromic layer is in its first state and is absorbed by said electrochromic layer when in its second state.

11. An arrangement according to claim 10 wherein the refractive index of the matching layer no more than 2 lower than the said second refractive index.

12. An arrangement according to any preceding claim wherein the means for to altering the charge in the electrochromic layer comprises a front electrode overlying said first surface of the electrochromic layer.

13. An arrangement according to claim 12 wherein said front electrode is a grid electrode.

14. An arrangement according to claim 13 wherein where present said grid electrode lies between said index matching layer and the electrochromic layer.

15. An arrangement according to claim 14 wherein the material of said index matching layer is selected from silicon, germanium, zinc sulphide, calcium fluoride and tin oxide.

16. An arrangement according to claim 12 wherein said front electrode is a continuous layer.

17. An arrangement according to claim 16 wherein said front electrode lies between said index matching layer and the electrochromic layer but is sufficiently thin not to destroy the effective optical contact between the electrochromic and index matching layers.

18. An arrangement according to claim 17 wherein material of the index matching layer is a semiconductor, and the region of the semiconductor adjacent the electrochromic layer is doped to provide said electrode.

19. An arrangement according to claim 16 wherein said front electrode is provided by said index matching layer.

20. An arrangement according to claim 19 wherein the material of said front electrode layer is selected from silicon and germanium.

21. An arrangement according to any preceding claim wherein the reflector is provided by the surface of a metallic layer or substrate.

22. An arrangement according to claim 21 wherein said reflector is a rear electrode forming part of the means for altering the charge in the electrochromic layer.

23. An arrangement according to any one of claims 1 to 20 wherein the reflector is provided by a dielectric mirror or passivated metallic layer.

24. An arrangement according to claim 23 wherein said reflector is overlaid by a rear electrode layer or grid forming part of the means for altering the charge in the electrochromic layer.

25. An arrangement according to any preceding claim wherein the stack further comprises an ion storage layer and/or or an ion conductive layer as part of said means for altering the charge in the electrochromic layer.

26. An arrangement according to any one of claims 1 to 24 wherein the stack further comprises an ion conductive layer between an ion storage layer and the electrochromic layer as part of said means for altering the charge in the electrochromic layer.

27. An arrangement according to claim 25 or claim 26 wherein the ion storage layer and/or ion conductive layer lies adjacent said second surface.

28. An arrangement according to claim 26 wherein the ion storage layer and/or ion conductive layer lies between said electrochromic layer and the reflector.

29. An arrangement according to claim 26 or claim 27 wherein the ion storage layer or the ion conductive layer comprises a porous dielectric said reflector.

30. An arrangement according to claim 25 or claim 26 wherein the ion storage layer and/or ion conductive layer lies adjacent said first surface.

31. An arrangement according to claim 30 wherein the ion storage layer and/or ion conductive layer constitutes said index matching layer.

32. An arrangement according to claim 30 wherein the electrochromic layer is in contact with the reflector.

33. An arrangement according to any one of claims 25 to 32 wherein said ion conductive layer comprises a material selected from tantalum oxide, lithium niobate or niobium pentoxide.

34. An electrochromic arrangement according to any one of claims 25 to 33 wherein said ion storage layer comprises a material selected from cerium oxide, vanadium oxide, titanium oxide, nickel oxide, tin oxide, amorphous tungsten oxide and mixtures thereof.

35. An electrochromic arrangement according to any preceding claim wherein the stack is supported by a substrate, with the reflector between the substrate and the electrochromic layer.

36. An electrochromic arrangement according to any one of claims 1 to 34 wherein the stack is supported by a substrate, with the electrochromic layer between the substrate and the reflector.

37. A arrangement according to claim 35 or claim 36 wherein said substrate is flexible.

38. An electrochromic arrangement according to any preceding claim wherein the electrochromic layer comprises crystalline tungsten oxide as herein defined.

39. An arrangement according to any preceding claim wherein said infra-red region is or comprises a selected one or both of the 3 to 5 and 8 to 12 micron windows.

40. An electrochromic arrangement according to claim 39 and claim 9, or claim 39 and claim 10, wherein the stack is arranged for preferential absorption of light in the 8 to 12 micron window, relative to the absorption of light in the 3 to 5 micron window, when the electrochromic layer is in its second state.

41. A method of operating an arrangement according to claim 39 wherein the amount of ions inserted into the tungsten oxide layer in the second state is controlled for preferential absorption in the 3 to 5 micron window, relative to light in the 8 to 12 micron window.

42. An electrochromic arrangement for use in a region of the infra-red spectrum, said arrangement comprising a stack of layers including an electrochromic layer having first and second opposed surfaces, and means to alter the charge in the electrochromic layer to change it between a first state which in said region is relatively transparent and exhibits a first refractive index, and a second state which in said region is relatively absorbing and exhibits a second refractive index, wherein
a reflector having a reflectivity of at least 50% in said region is opposed to said second surface;
the stack of layers includes an ion conduction or ion storage layer in effective optical contact with said first surface; and
the optical path to the reflector is generally light transmissive in said region when the electrochromic layer is in its first state.

43. An electrochromic arrangement according to claim 42 wherein the electrochromic layer is immediately adjacent said reflector.

44. An electrochromic arrangement according to claim 42 wherein the electrochromic layer is spaced from said reflector by an ion storage layer and/or an ion conducting layer.

43. A variable transmission electrochromic arrangement for use in at least one band in the infra-red region, said device comprising a stack of layers, said stack having a first surface for receiving incident radiation and a second opposed surface, said stack comprising an electrochromic layer and an index matching layer which forms an optical interface with the one surface of the electrochromic layer nearer said first surface, and means to alter the charge in the electrochromic layer to change it between a first state which is relatively transparent in said band and which has a first refractive index, and a second state which is relatively absorbing in said band and which has a second refractive index, the index matching layer having a third refractive index selected to reduce the amount of light reflected at the said interface compared with an interface to air, wherein the materials and construction of the device are selected such that the optical path between the first and second surfaces is generally light transmissive when the electrochromic layer is in its first state and generally light absorbing when the electrochromic layer is in its second state.

44. An electrochromic arrangement according to claim 43 wherein the reduction in the amount of light reflected at the said other surface in said region is effective when said electrochromic layer is in the charged state.

45. An electrochromic arrangement according to claim 43 wherein the amount of light reflected at the said other surface in said region is less than 25% when the electrochromic layer is in its charged state.

46. An electrochromic arrangement substantially as hereinbefore described and shown in FIGS. 1 and 2, or FIG. 3, or FIG. 4, of the accompanying drawings.
